(19) United States
(12) Patent Application Publication
(10) Pub. No.: US 2025/0353276 A1
(43) Pub. Date: Nov. 20, 2025

(54) RECYCLABLE FOAM COMPOSITE

(71) Applicant: GM Global Technology Operations LLC, Detroit, MI (US)

(72) Inventor: Edward Thaddeus Kuczynski, Ann Arbor, MI (US)

(21) Appl. No.: 18/663,769

(22) Filed: May 14, 2024

(51) Int. Cl. B32B 5/24; B32B 3/14; B32B 5/20; B32B 7/09; B32B 37/04; B32B 38/00

(52) U.S. Cl. CPC B32B 5/245; B32B 3/14; B32B 5/20; B32B 7/09; B32B 37/04; B32B 38/0004; B32B 2262/0215; B32B 2262/0276; B32B 2266/0292; B32B 2305/08; B32B 2605/00

(57) ABSTRACT

A composite component includes an outer skin that is formed from a thermoplastic polyurethane (TPU) elastomer, within a thermoforming mold, into a desired shape, a mesh reinforcement layer formed from a blend of TPU and polyester fibers and attached to an inner surface of the outer skin, and a padding that is formed from a TPU foam and applied to the inner surface of the outer skin and comprising one of liquid TPU foam that is poured within the desired shape of the outer skin, a plurality of gas-filled TPU beads that are melted to one another at points of contact of outer surfaces of adjacent beads, or one of TPU foam that is molded to a desired shape, or TPU foam that is cut in the desired shape from a bulk piece of TPU foam.

### INTRODUCTION

The present invention relates generally to a composite component made from thermoplastic polyurethane (TPU), wherein all sub-components of the composite component are made from TPU, and thus are adapted for unitary closed-loop recyclability with completely recoverable content.

### BACKGROUND OF THE INVENTION

Modern vehicle seats are generally made from an outer skin (trim) that is made from vinyl, cloth, leather, etc., and foam padding that is made from a thermoset polyurethane which is incapable of closed-loop recycling. Thus, for recycling, such a seat must be mechanically separated into outer skin and non-homologous thermoset polyurethane (foam padding).

Thus, there is a need for a composite component and method for making a composite component wherein all features of the composite component are made from TPU and are suited for unitary closed-loop recyclability with completely recoverable content.

### SUMMARY

According to several aspects of the present disclosure, a seat cushion for a vehicle seat includes an outer skin that is formed from a thermoplastic polyurethane (TPU) elastomer, and a padding that is formed from a TPU foam, wherein, the outer skin and the padding are adapted for unitary closed-loop recyclability with completely recoverable content.

According to another aspect, the outer skin includes a mesh reinforcement layer formed from TPU fibers.

According to another aspect, the TPU fibers of the mesh reinforcement layer comprises a blend of TPU fibers and polyester fibers.

According to another aspect, the outer skin further includes at least one attachment clip made from TPU and adapted to secure the outer skin to a frame of the vehicle seat, wherein, the outer skin, the at least one attachment clip and the padding are adapted for unitary closed-loop recyclability with completely recoverable content.

According to another aspect, the seat cushion further includes at least one of stitching, made from TPU fibers, and adapted to connect two separate pieces of TPU skin to form the outer skin, stitching, made from TPU fibers, and adapted to secure the outer skin to the padding, and at least one tie-down clip, made from TPU, adapted to secure the outer skin to the padding.

According to another aspect, the outer skin is formed, within a thermoforming mold, into a desired shape and the padding is applied to an inner surface of the outer skin, within the desired shape.

According to another aspect, the padding comprises liquid TPU foam that is poured within the desired shape of the outer skin, wherein the liquid TPU foam expands within the desired shape and cures to a solid foam structure.

According to another aspect, the padding comprises a plurality of gas-filled TPU beads that are melted to one another at points of contact of outer surfaces of adjacent beads, wherein the desired shape of the outer skin is filled with gas-filled TPU beads and steam is applied to the gas-filled TPU beads, melting the outer surfaces of the gas-filled TPU beads and melting adjacent beads to one another, forming a solid foam structure when cooled.

According to another aspect, the padding comprises one of TPU foam that is molded to a desired shape, or TPU foam that is cut in the desired shape from a bulk piece of TPU foam, and, wherein, the padding is applied by placing the TPU foam of the desired shape within the corresponding desired shape of the molded TPU outer skin.

According to another aspect, the seat cushion further includes a second skin formed from a TPU elastomer, that is heat welded onto the inner surface of the outer skin after the padding is applied, wherein the outer skin and the second skin define a bladder encapsulating the padding therein.

According to several aspects of the present disclosure, a method of forming a seat cushion for a vehicle seat includes forming, within a thermoforming mold, an outer skin that comprises a thermoplastic polyurethane (TPU) elastomer, into a desired shape, and applying a padding, that comprises a TPU foam, to an inner surface of the outer skin, within the desired shape, wherein, the outer skin and the padding are adapted for unitary closed-loop recyclability with completely recoverable content.

According to another aspect, the method further includes applying a mesh reinforcement layer, formed from TPU fibers, to an inner surface of the outer skin prior to applying the padding.

According to another aspect, the applying a mesh reinforcement layer to an inner surface of the outer skin prior to applying the padding further includes, forming the mesh reinforcement layer from a blend of TPU fibers and polyester fibers.

According to another aspect, the method further includes securing the outer skin to a frame of the vehicle seat with at least one attachment clip made from TPU, wherein, the outer skin, the at least one attachment clip and the foam filler are adapted for unitary closed-loop recyclability with completely recoverable content.

According to another aspect, the method further includes at least one of connecting two separate pieces of TPU skin to form the outer skin with stitching, made from TPU fibers, prior to applying the padding, securing the outer skin to the padding with stitching, made from TPU fibers, after applying the padding, and securing the outer skin to the padding with at least one tie-down clip, made from TPU, after applying the padding.

According to another aspect, the applying a padding, that comprises a TPU foam, to an inner surface of the outer skin, within the desired shape further includes pouring liquid TPU foam within the desired shape of the outer skin, and allowing the liquid TPU foam to expand within the desired shape and cure to a solid foam structure.

According to another aspect, the applying a padding, that comprises a TPU foam, to an inner surface of the outer skin, within the desired shape further includes filling the desired shape of the outer skin with a plurality of gas-filled TPU beads, applying steam to the plurality of gas-filled TPU beads, and melting the plurality of gas-filled TPU beads to one another at points of contact of outer surfaces of adjacent beads and forming a solid foam structure when cooled.

According to another aspect, the method further includes, prior to applying the padding, one of molding TPU foam to a desired shape, or cutting TPU foam in the desired shape from a bulk piece of TPU foam, and wherein, the applying a padding, that comprises a TPU foam, to an inner surface of the outer skin, within the desired shape further includes placing the TPU foam of the desired shape within the corresponding desired shape of the molded TPU outer skin.

According to another aspect, the method further includes applying a second skin formed from a TPU elastomer onto the inner surface of the outer skin after the padding is applied, and heat welding the second skin onto the inner surface of the outer skin, wherein the outer skin and the second skin define a bladder encapsulating the padding therein.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a composite component in accordance with an exemplary embodiment wherein the composite component is a seat cushion for a vehicle seat;

FIG. 2 is perspective view of the seat cushion shown in FIG. 1, wherein a portion of the seat cushion is shown in section;

FIG. 3 is a enlarged portion of FIG. 2 as indicated by the portion of FIG. 2 labeled “FIG. 3”;

FIG. 4 is an exploded schematic view of an outer skin, reinforcement layer and padding of the seat cushion shown in FIG. 1 through FIG. 3;

FIG. 5 is a schematic view of the outer skin with the reinforcement layer adhered to an inner surface of the outer skin;

FIG. 6 is an enlarged view of FIG. 1 as indicated by the portion of FIG. 1 labeled “FIG. 6”;

FIG. 7A is a schematic perspective view illustrating the application of liquid TPU foam to the inner surface of the outer skin;

FIG. 7B is a side view of FIG. 7A;

FIG. 7C is a side view of the outer skin after liquid TPU foam has expanded and cured therein;

FIG. 8A is a schematic side view of the outer skin wherein the padding comprises a plurality of gas-filled TPU beads;

FIG. 8B is an enlarged view of two gas-filled TPU beads that are melted together at a point of contact;

FIG. 9 is a schematic diagram illustrating the application of padding that comprises a TPU foam block to the outer skin;

FIG. 10A is a schematic diagram illustrating the application of a second skin to the outer skin after the padding has been applied;

FIG. 10B is a schematic diagram wherein the second skin has been applied to the inner surface of the outer skin;

FIG. 10C is a schematic diagram wherein the second skin has been heat welded to the inner surface of the outer skin; and

FIG. 11 is a flow chart illustrating a method in accordance with an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

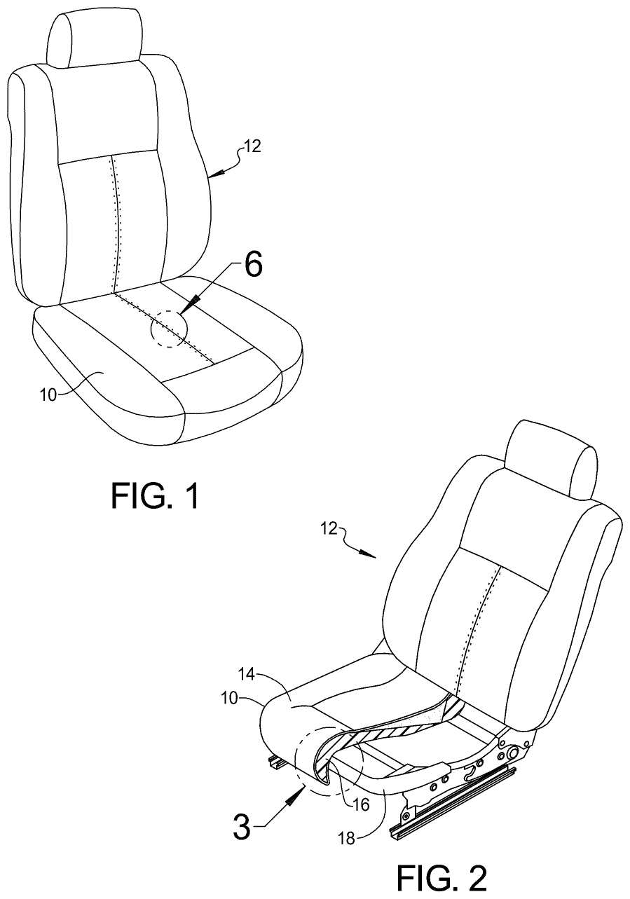

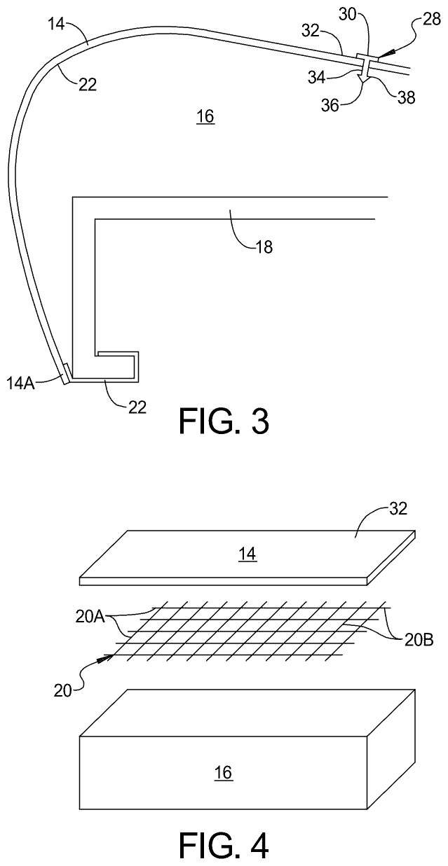

Referring to FIG. 1, FIG. 2 and FIG. 3, a seat cushion 10 for a vehicle seat 12, includes an outer skin 14 that is formed from a thermoplastic polyurethane (TPU) elastomer, and a padding 16 that is formed from a TPU foam. Because both the outer skin 14 and the padding 16 are made from TPU, they are adapted for unitary closed-loop recyclability with completely recoverable content.

In closed-loop, or primary recycling, used plastic is endlessly recycled back into new items of the same quality and type. For instance, turning drinks bottles back into drinks bottles. The continual mechanical recycling of plastic without reduction in quality is challenging due to cumulative polymer degradation and risk of contaminant build-up. Very little recycled material is able to be recycled in a closed loop. TPU materials (elastomers, foam, etc.) are closed-loop recyclable.

In open-loop recycling, also known as secondary recycling, or downcycling, the quality of the plastic is reduced each time it is recycled, so that the material eventually becomes unrecyclable. It is the most common type of recycling. Recycling PET bottles into fleece or other fibers is a common example, and accounts for the majority of PET recycling. Thermoset polymers, such as thermoset polyurethane which is commonly used for the foam padding within vehicle seats, does not melt. Technologies have been developed for mechanical recycling of thermoset polymers which usually involves breaking the material down to small particles (crumbs), which can then be mixed with a binding agent to form a composite material. For instance, thermoset polyurethanes can be recycled as re-bonded crumb foam (chip foam). Life-cycle assessment shows recycling to be of ecological benefit. Recycling can displace demand for fresh plastic. However, if it is used to produce items that would not otherwise have been made, such as with open-loop recycling, then it is not displacing production and is of little or no benefit to the environment. Alternate thermoset polyurethane recycling can be achieved through glycolysis, hydrolysis, aminolysis, pyrolysis, etc., where polyurethane chemical chains are broken and product can be used as a raw material polyol. Glycolysis is the treatment of thermoset polyurethane with a glycol, Hydrolysis is the treatment with esters of phosphoric acid, aminolysis uses low-weight alkanolamines. A drawback of this recycling process is that resultant polyol is only suitable for rigid, or semi-rigid, products and applications. Another issue with the glycolysis, hydrolysis, aminolysis, pyrolysis, etc. processes is a side reaction that yields a secondary, undesired, product: Methylenedianiline (MDA), an aromatic and carcinogen amine. Further, items such as vehicle seats that include, for example, thermoplastic outer skin and thermoset polyurethane foam padding require disassembly to make recycling possible, and even then, only some parts, such as the thermoplastic outer skin, can be closed-loop recycled.

Thermoplastic polyurethane (TPU) is any of a class of polyurethane plastics with many properties, including elasticity, transparency, and resistance to oil, grease, and abrasion. Technically, they are thermoplastic elastomers consisting of linear segmented block copolymers composed of hard and soft segments. TPU is a block copolymer consisting of alternating sequences of hard and soft segments or domains formed by the reaction of (1) diisocyanates with short-chain diols (so-called chain extenders) and (2) diisocyanates with long-chain diols. By varying the ratio, structure and/or molecular weight of the reaction compounds, an enormous variety of different TPU can be produced. This allows urethane chemists to fine-tune the polymer's structure to the desired final properties of the material.

A TPU resin consists of linear polymeric chains in block-structures. Such chains contain low polarity segments which are rather long (called soft segments), alternating with shorter, high polarity segments (called hard segments). Both types of segments are linked by covalent links so that they actually form block-copolymers. The miscibility of the hard and soft segments in TPU depends on the differences in their glass transition temperature (Tg) which occurs at the onset of micro-Brownian segmental motion, identifiable by dynamic mechanical spectra. For an immiscible TPU, the loss modulus spectrum typically shows double peaks, each of which is assigned to the Tg of one component. If the two components are miscible, the TPU will be characterized by a single broad peak whose position lies between that of the two original Tg peaks of the pure components.

The polarity of the hard pieces creates a strong attraction between them, which causes a high degree of aggregation and order in this phase, forming crystalline or pseudo crystalline areas located in a soft and flexible matrix. This so-called phase separation between both blocks can be more or less important, depending on the polarity and the molecular weight of the flexible chain, the production conditions, etc. The crystalline or pseudo crystalline areas act as physical cross-links, which account for the high elasticity level of TPU, whereas the flexible chains will impart the elongation characteristics to the polymer.

These “pseudo crosslinks”, however, disappear under the effect of heat, and thus the classical extrusion and injection molding processing methods are applicable to these materials. Consequently, TPU scrap can be reprocessed (closed-loop recycling). TPU has many applications, including automotive instrument panels, caster wheels, power tools, sporting goods, medical devices, drive belts, footwear, inflatable rafts, fire hoses, and a variety of extruded film, sheet and profile uses. TPU is also a popular material found in flexible outer cases of devices like mobile phones and keyboard protectors. TPU is well known for its applications in wire and cable jacketing, hose and tube, in adhesive and textile coating applications, and as an impact modifier of other polymers. It is also used in high-performance films, such as high impact resistant glass structures. TPU is the thermoplastic elastomer used in fused filament deposition (FFD) 3D printing. The absence of warping and lack of need for primer makes it an ideal filament for 3D printers when objects need to be flexible and elastic. Since TPU is a thermoplastic, it can be melted by the 3D printer's hotend, printed, then cooled into an elastic solid. The performance and adaptability of TPU in various applications can largely be attributed to its hardness, as represented by the Shore A scale. TPU powders are also used for other 3D printing processes, such as selective laser sintering (SLS) and 3D inkjet printing. It is also used in large vertical injection or extrusion molding machines to print directly without the intermediate step of filament extrusion or powder preparation. Recently, TPU foams have been developed, providing a broader application for TPU and enabling systems and methods according to features of the present disclosure.

Thus, the seat cushion 10 of the vehicle seat 12 shown in FIG. 1, FIG. 2 and FIG. 3 provides the advantage of allowing manufacture of a composite component (seat cushion 10) that includes an outer skin 14 made from a TPU elastomer, such as know in the industry, and a foam padding 16 that is made from TPU foam, which has been, until recently, unavailable. The advantage of this arrangement is that the assembled seat cushion 10, including both the outer skin 14 and the foam padding 16 can be removed from framework 18 of the vehicle seat 12 and unitarily closed-loop recycled. This provides economic and environmental advantages, increasing the overall recyclability of the seat cushion 10 and reducing preparation and separation needed for recycling of traditional seat cushions.

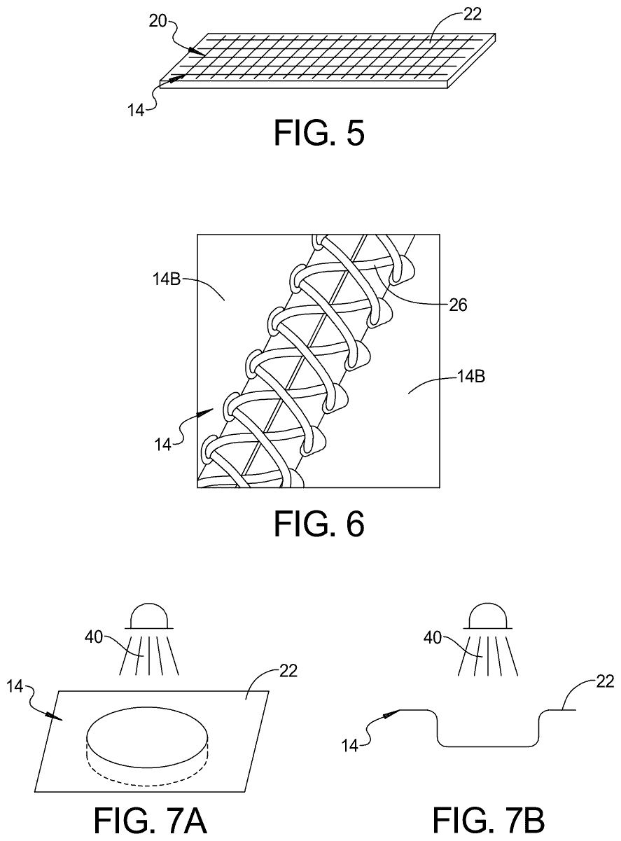

Referring to FIG. 4 and FIG. 5, in an exemplary embodiment the outer skin 14 includes a mesh reinforcement layer 20 formed from TPU fibers 20A. The mesh reinforcement layer 20 is adhered to an inner surface 22 of the outer skin 14, as shown in FIG. 5, wherein when the padding 16 is applied to the outer skin 14, the reinforcement layer 20 is positioned adjacent the padding 16. In another exemplary embodiment the TPU fibers 20A of the mesh reinforcement layer 20 includes a blend of TPU fibers 20A and polyester fibers 20B. Known and currently used TPU skins use woven reinforcement fibers that are not able to be closed-loop recycled, and cannot be separated from the TPU outer skin, thus preventing closed-loop recycling of the TPU outer skin. The reinforcement layer 20 made from TPU and/or polyester fibers 20A, 20B can be unitarily closed-loop recycled along with the outer skin 14 and the padding 16, thus allowing the seat cushion 10 to be made from entirely recoverable content.

Referring again to FIG. 3, in another exemplary embodiment, the outer skin 14 further includes at least one attachment clip 24 made from TPU and adapted to secure the outer skin 14 to a frame 18 of the vehicle seat 12. The at least one attachment clip 24 is attached to an edge 14A of the outer skin 14 and secures the outer skin to the frame 18 of the vehicle seat 12. The at least one attachment clip 24 may be adhered to the edge 14A of the outer skin 14 by heat welding, or the at least one attachment clip 24 may be sewn to the edge 14A of the outer skin 14 with thread made from TPU fibers. Thus, when the seat cushion 10 reaches the end of its' life-cycle, the entire seat cushion 10, including the outer skin 14, the at least one attachment clip 24 and the foam padding 16 are adapted for unitary closed-loop recyclability with completely recoverable content.

In another exemplary embodiment, the seat cushion 10 further includes at least one of, 1) stitching 26, made from TPU fibers, and adapted to connect two separate pieces of TPU skin 14B to form the outer skin 14, 2) stitching 26, made from TPU fibers, and adapted to secure the outer skin 14 to the padding 16, and 3) at least one tie-down clip 28, made from TPU, adapted to secure the outer skin 14 to the padding 16. Referring to FIG. 6, stitching 26 made from TPU fibers is used to attach two pieces of TPU elastomer 14B together to form the outer skin 14 of the seat cushion 10. Additionally, such stitching 26, using TPU fibers, may extend into the padding 16 behind the outer skin 14, thus securing the outer skin 14 to the padding 16. In an exemplary embodiment, the stitching 26 shown in FIG. 6 both connects two separate pieces of TPU elastomer 14B skin together and extends into the padding 16 to both form the outer skin 14 and secure the outer skin 14 to the padding 16. It should be understood that such stitching 26 may also be used only to secure the outer skin 14 to the padding 16.

Referring again to FIG. 3, at least one tie-down clip 28, made from TPU, is adapted to extend through the outer skin 14 and into the padding 16, wherein the at least one tie down clip 28 includes features adapted to engage the outer skin 14 and the padding 16 to secure the outer skin 14 to the padding 16. As shown, the at least one tie-down clip 28 includes a head portion 30 adapted to engage an outer surface 32 of the outer skin 14, a shaft 34 having a sharp distal end 36 adapted to penetrate the outer skin 14 and the padding 16 when the at least one tie-down clip 28 is pressed into the seat cushion 10, and features 38, such as barbs or fins, extending radially outward from the shaft 34 and adapted to engage the padding 16 once the at least one tie-down clip 28 is pressed into place and secure the at least one tie-down clip 28 in place, thereby securing the outer skin 14 to the padding 16. It should be understood that different variations of the at least one tie-down clip 28 may be used without departing from the novelty of the present disclosure.

In an exemplary embodiment, the outer skin 14 is formed, within a thermoforming mold, into a desired shape and the padding 16 is applied to the inner surface 22 of the outer skin 14, within the desired shape. Thermoforming is a manufacturing process used to shape sheet thermoplastic materials to required profiles/shapes through the application of heat and pressure/vacuum. Various techniques of thermoforming include: vacuum forming, pressure forming, and combined vacuum/pressure forming. Thermoforming is employed in the manufacture of both simple and relatively complex single-sheet parts that follow a relatively low-stress process, by avoiding sharp transitions in the mold profile.

Thermoforming is a simple process whereby a heated sheet of thermoplastic is stretched across a 3D-profile former and then forced into close conformity with it. A thermoplastic sheet is heated until it meets the required viscous, rubbery, semi-solid state, generally high up the glass-transition range. The necessary temperature for this is at the upper end of the glass-transition range, whereby interchain bonds that form the crystalline matrix are weakened and motile but not fully overcome.

The heated sheet is molded into a specific shape using two steps. First, the tool is raised on a movable table that rises to meet the underside of the sheet. This forces the heated polymer to drape over the tool, conforming to height but not overall shape. Then additional force is applied by vacuum below or pressure above, or a combination of these. An upper tool component can also be employed to assist in forming particular regions. Thus, the heated TPU outer skin 14 is formed to the desired shape.

The formed outer skin 14 is cooled to return the TPU material to the solid state, retaining the desired shape as part of a now 3D sheet. Vacuum or pressure is retained during cooling, to prevent shape relaxation as the TPU material returns to rigidity. The completion of the thermoforming process leaves a 3D profile (or multiples of the same profile) either as a male or female net shape relative to the sheet's position. This incomplete part is removed from the thermoforming machine, either by hand or by automation, and is then passed to a trimming stage, wherein excess material is cut away to achieve the final desired shape of the outer skin 14. It should be understood that the description above is a non-limiting example of thermoforming the outer skin 14. The outer skin 14 may be thermoformed to the desired shape by other methods known in the industry without departing from the novel aspects of the present disclosure.

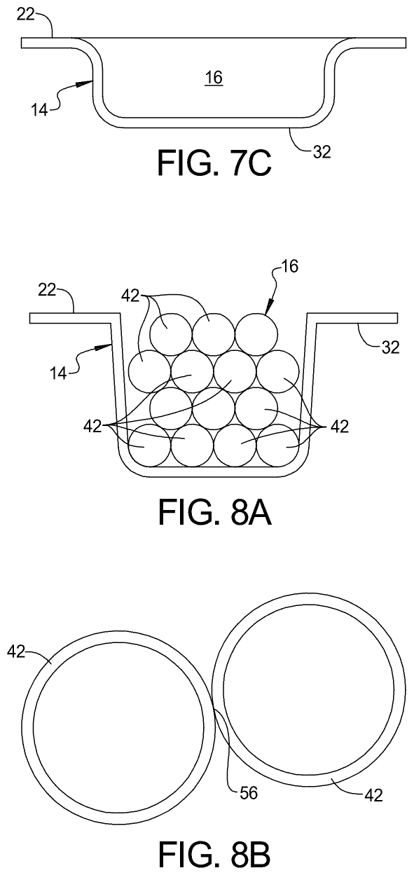

Referring to FIG. 7A, FIG. 7B and FIG. 7C, in one exemplary embodiment, the padding 16 comprises liquid TPU foam 40 that is poured or sprayed within the desired shape of the outer skin 14 as shown in FIG. 7A and FIG. 7B. The liquid TPU foam 40 expands within the desired shape and cures to a solid foam structure defining the padding 16, as shown in FIG. 7C.

Referring to FIG. 8A and FIG. 8B, in another exemplary embodiment, the padding 16 comprises a plurality of gas-filled TPU beads 42 that are melted to one another at points of contact of outer surfaces of adjacent beads. Referring to FIG. 8A, the desired shape of the outer skin is filled with gas-filled TPU beads 42 and steam is applied to the gas-filled TPU beads 42. The steam melts the outer surfaces of the gas-filled TPU beads 42 and melts adjacent beads 42 to one another at points of contact 56, as shown in FIG. 8B, forming a solid foam structure conforming to the desired shape of the outer skin 14 and defining the padding 16 when cooled.

The gas-filled TPU beads 42 are pre-expanded using steam or other expansion agents. The expanded TPU beads 42 are then cooled, resulting in lightweight, closed-cell beads. Prior to placing the gas-filled TPU beads 42 within the desired shape of the thermoformed outer skin 14, the beads 42 may be pre-expanded further to achieve the desired density. After the desired shape of the outer skin 14 is filled with gas-filled TPU beads 42, as shown in FIG. 8A, steam and/or pressure is applied to the gas-filled TPU beads 42. The steam further expands the gas-filled TPU beads 42 and fuses the beads 42 together, forming a solid foam shape corresponding to the desired shape of the outer skin 14. The seat cushion 10 made using gas-filled TPU beads 42 provides excellent insulation properties due to the trapped gas within the gas-filled TPU beads 42, is lightweight, and provides buoyancy and water resistance due to the closed-cell structure of the gas-filled TPU beads 42.

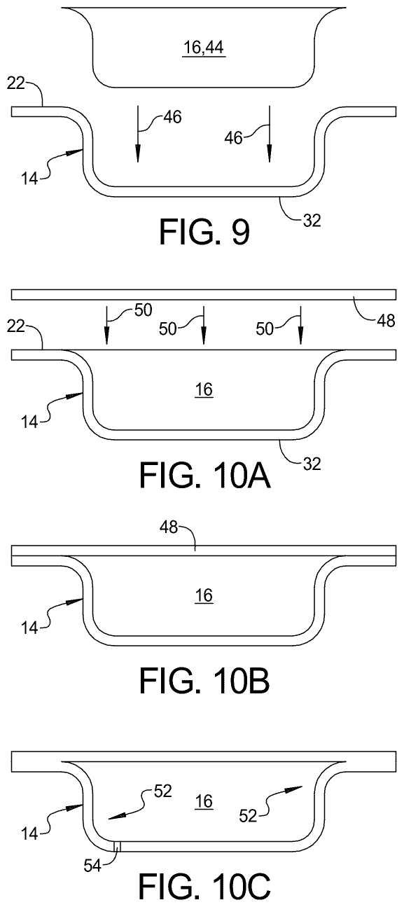

In another exemplary embodiment, the padding 16 comprises a block of TPU foam 44 that is one of TPU foam that is molded to a desired shape, or TPU foam that is cut in the desired shape from a bulk piece of TPU foam. Referring to FIG. 9, the padding 16 is applied by placing the block of TPU foam 44 of the desired shape within the corresponding desired shape of the thermoformed TPU outer skin 14, as indicated by arrows 46. Once placed within the desired shape of the thermoformed outer skin 14, the TPU foam padding 16 may be adhered to the inner surface 22 of the thermoformed outer skin 14 by heat welding or other known methods.

In still another exemplary embodiment, the seat cushion 10 further includes a second skin 48 formed from a TPU elastomer, that is heat welded onto the inner surface 22 of the outer skin 14 after the padding 16 is applied. Referring to FIG. 10A, after the padding 16 has been applied within the desired shape of the thermoformed outer skin 14 by any of the methods discussed above, the second skin 48 is placed onto the inner surface 22 of the outer skin 14 as shown by arrows 50. Referring to FIG. 10B, after the second skin 48 is placed onto the inner surface 22 of the outer skin 14, the second skin 48 is adhered to the inner surface 22 of the outer skin 14 by heat welding or other suitable methods, wherein, referring to FIG. 10C, the outer skin 14 and the second skin 48 define a bladder 52 encapsulating the padding 16 therein.

Depending on the shape of the outer skin 14, the presence of the bladder 52 may or may not be visible by looking at the seat cushion 10. Further, the bladder 52, having padding 16 that is compressible/expandable TPU foam therein may provide selective expansion of the bladder 52, using an external pump or mechanical means, to provide selectively actuatable features, such as an adjustable support or massage system. In some embodiments, the bladder 52 includes a vent 54 adapted to let air exit and enter the bladder 52, preventing the bladder 52 from behaving as a sealed balloon, wherein the bladder 52 is able to be compressed under external pressure to provide a cushioning effect as the padding 16 therein compresses and is able to expand back to an original shape once the external pressure is removed.

Thus, a composite component, such as a seat cushion 10, according to the present disclosure, provides complex design features and functionality, while being completely closed-loop recyclable with the ability to recover 100% of the materials used within the seat cushion 10. Further, a composite component 10 in accordance with the teachings of the present disclosure does not have to be mechanically separated prior to recycling. For example, the seat cushion 10, including the outer skin 14, the padding 16, the at least one attachment clip 24, the at least one tie-down clip 28, the stitching 26, and possibly a second skin 48 defining a bladder 52 therein, can be removed from the frame 18 of the vehicle seat 12 and unitarily recycled. The entire seat cushion 10 can be life-cycled into new TPU.

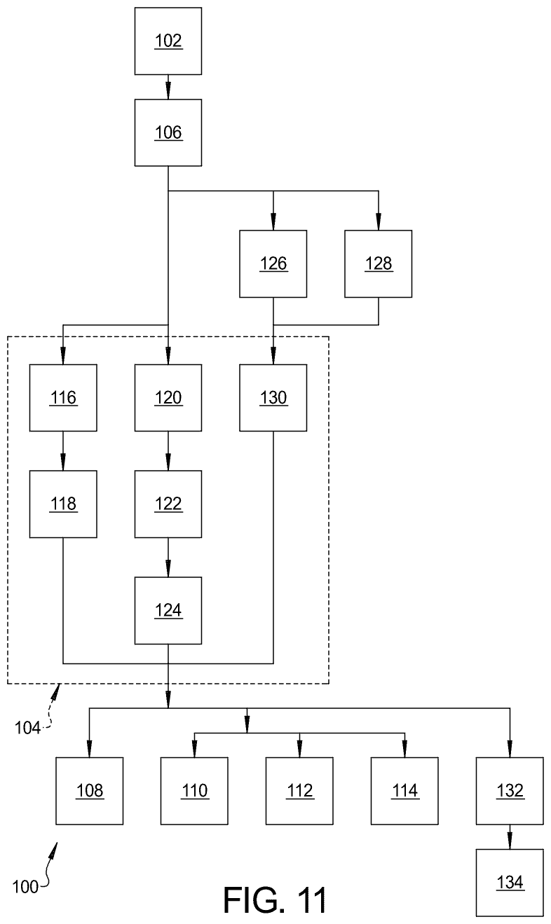

Referring to FIG. 11, a method 100 of forming a seat cushion 10 for a vehicle seat 12 includes, beginning at block 102, forming, within a thermoforming mold, an outer skin 14 that comprises a thermoplastic polyurethane (TPU) elastomer, into a desired shape, and, moving to block 104, applying a padding 16, that comprises a TPU foam, to an inner surface 22 of the outer skin 14, within the desired shape, wherein, the outer skin 14 and the padding 16 are adapted for unitary closed-loop recyclability with completely recoverable content.

In an exemplary embodiment, the method 100 further includes, moving to block 106, applying a mesh reinforcement layer 20, formed from TPU fibers 20A, to an inner surface 22 of the outer skin 14 prior to applying the padding 16. In another exemplary embodiment, the applying a mesh reinforcement layer 20 to an inner surface 22 of the outer skin 14 prior to applying the padding 16 at block 106 further includes, forming the mesh reinforcement layer 20 from a blend of TPU fibers 20A and polyester fibers 20B.

In an exemplary embodiment, the method 100 further includes, moving from block 104 to block 108, securing the outer skin 14 to a frame 18 of the vehicle seat 12 with at least one attachment clip 24 made from TPU, wherein, the outer skin 14, the at least one attachment clip 24 and the padding 16 are adapted for unitary closed-loop recyclability with completely recoverable content.

In another exemplary embodiment, the method 100 further includes at least one of, moving from block 104 to block 110, connecting two separate pieces of TPU skin 14B to form the outer skin 14 with stitching 26, made from TPU fibers, prior to applying the padding 16, moving from block 104 to block 112, securing the outer skin 14 to the padding 16 with stitching 26, made from TPU fibers, after applying the padding 16, and, moving from block 104 to block 114, securing the outer skin 14 to the padding 16 with at least one tie-down clip 28, made from TPU, after applying the padding 16.

In an exemplary embodiment, the applying a padding 16, that comprises a TPU foam, to an inner surface 22 of the outer skin 14, within the desired shape at block 104 further includes, moving to block 116, pouring liquid TPU foam 40 within the desired shape of the outer skin 14, and, moving to block 118, allowing the liquid TPU foam 40 to expand within the desired shape and cure to a solid foam structure.

In an exemplary embodiment, the applying a padding 16, that comprises a TPU foam, to an inner surface 22 of the outer skin 14, within the desired shape at block 104 further includes, moving to block 120, filling the desired shape of the outer skin 14 with a plurality of gas-filled TPU beads 42, moving to block 122, applying steam to the plurality of gas-filled TPU beads 42, and, moving to block 124, melting the plurality of gas-filled TPU beads 42 to one another at points of contact 56 of outer surfaces of adjacent beads 42 and forming a solid foam structure when cooled.

In another exemplary embodiment, the method 100 includes, prior to apply the padding at block 104, one of, moving from block 106 to block 126, molding TPU foam to a desired shape, or, moving from block 106 to block 128, cutting TPU foam in the desired shape from a bulk piece of TPU foam, and wherein, the applying a padding 16, that comprises a TPU foam, to an inner surface 22 of the outer skin 14, within the desired shape at block 104 further includes, moving to block 130, placing the TPU foam of the desired shape within the corresponding desired shape of the thermoformed TPU outer skin 14.

In another exemplary embodiment, the method 100 further includes, moving from block 104 to block 132, applying a second skin 48 formed from a TPU elastomer onto the inner surface 22 of the outer skin 14 after the padding 16 is applied, and, moving to block 134, heat welding the second skin 48 onto the inner surface 22 of the outer skin 14, wherein the outer skin 14 and the second skin 48 define a bladder 52 encapsulating the padding 16 therein.

A composite component (seat cushion 10) and method 100 of the present disclosure offers several advantages. These include allowing a composite component, such as the seat cushion 10, to have complex design features and functionality, while being completely closed-loop recyclable with the ability to recover 100% of the materials used within the seat cushion 10. Further, a composite component 10 in accordance with the teachings of the present disclosure does not have to be mechanically separated prior to recycling. For example, the seat cushion 10, including the outer skin 14, the padding 16, the at least one attachment clip 24, the at least one tie-down clip 28, the stitching 26, and possibly a second skin 48 defining a bladder 52 therein, can be removed from the frame 18 of the vehicle seat 12 and unitarily recycled. The entire seat cushion 10 can be life-cycled into new TPU.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A seat cushion for a vehicle seat, comprising:
an outer skin that is formed from a thermoplastic polyurethane (TPU) elastomer; and
a padding that is formed from a TPU foam;
wherein, the outer skin and the padding are adapted for unitary closed-loop recyclability with completely recoverable content.

2. The seat cushion of claim 1, wherein the outer skin includes a mesh reinforcement layer formed from TPU fibers.

3. The seat cushion of claim 2, wherein the TPU fibers of the mesh reinforcement layer comprises a blend of TPU fibers and polyester fibers.

4. The seat cushion of claim 2, wherein the outer skin further includes at least one attachment clip made from TPU and adapted to secure the outer skin to a frame of the vehicle seat, wherein, the outer skin, the at least one attachment clip and the padding are adapted for unitary closed-loop recyclability with completely recoverable content.

5. The seat cushion of claim 2, further including at least one of:
stitching, made from TPU fibers, and adapted to connect two separate pieces of TPU skin to form the outer skin;
stitching, made from TPU fibers, and adapted to secure the outer skin to the padding; and
at least one tie-down clip, made from TPU, adapted to secure the outer skin to the padding.

6. The seat cushion of claim 2, wherein the outer skin is formed, within a thermoforming mold, into a desired shape and the padding is applied to an inner surface of the outer skin, within the desired shape.

7. The seat cushion of claim 6, wherein the padding comprises liquid TPU foam that is poured within the desired shape of the outer skin, wherein the liquid TPU foam expands within the desired shape and cures to a solid foam structure.

8. The seat cushion of claim 6, wherein the padding comprises a plurality of gas-filled TPU beads that are melted to one another at points of contact of outer surfaces of adjacent beads, wherein the desired shape of the outer skin is filled with gas-filled TPU beads and steam is applied to the gas-filled TPU beads, melting the outer surfaces of the gas-filled TPU beads and melting adjacent beads to one another, forming a solid foam structure when cooled.

9. The seat cushion of claim 6, wherein the padding comprises one of:
TPU foam that is molded to a desired shape; or
TPU foam that is cut in the desired shape from a bulk piece of TPU foam; and
wherein, the padding is applied by placing the TPU foam of the desired shape within the corresponding desired shape of the molded TPU outer skin.

10. The seat cushion of claim 6, further including a second skin formed from a TPU elastomer, that is heat welded onto the inner surface of the outer skin after the padding is applied, wherein the outer skin and the second skin define a bladder encapsulating the padding therein.

11. A method of forming a seat cushion for a vehicle seat, comprising:
forming, within a thermoforming mold, an outer skin that comprises a thermoplastic polyurethane (TPU) elastomer, into a desired shape; and
applying a padding, that comprises a TPU foam, to an inner surface of the outer skin, within the desired shape;
wherein, the outer skin and the padding are adapted for unitary closed-loop recyclability with completely recoverable content.

12. The method of claim 11, further including applying a mesh reinforcement layer, formed from TPU fibers, to an inner surface of the outer skin prior to applying the padding.

13. The method of claim 12, wherein the applying a mesh reinforcement layer to an inner surface of the outer skin prior to applying the padding further includes, forming the mesh reinforcement layer from a blend of TPU fibers and polyester fibers.

14. The method of claim 12, further including securing the outer skin to a frame of the vehicle seat with at least one attachment clip made from TPU, wherein, the outer skin, the at least one attachment clip and the foam filler are adapted for unitary closed-loop recyclability with completely recoverable content.

15. The method of claim 12, further including at least one of:
connecting two separate pieces of TPU skin to form the outer skin with stitching, made from TPU fibers, prior to applying the padding;
securing the outer skin to the padding with stitching, made from TPU fibers, after applying the padding; and
securing the outer skin to the padding with at least one tie-down clip, made from TPU, after applying the padding.

16. The method of claim 12, wherein the applying a padding, that comprises a TPU foam, to an inner surface of the outer skin, within the desired shape further includes:
pouring liquid TPU foam within the desired shape of the outer skin; and
allowing the liquid TPU foam to expand within the desired shape and cure to a solid foam structure.

17. The method of claim 12, wherein the applying a padding, that comprises a TPU foam, to an inner surface of the outer skin, within the desired shape further includes:
filling the desired shape of the outer skin with a plurality of gas-filled TPU beads;
applying steam to the plurality of gas-filled TPU beads; and
melting the plurality of gas-filled TPU beads to one another at points of contact of outer surfaces of adjacent beads and forming a solid foam structure when cooled.

18. The method of claim 12, wherein the method further includes, prior to applying the padding, one of:
molding TPU foam to a desired shape; or
cutting TPU foam in the desired shape from a bulk piece of TPU foam; and
wherein, the applying a padding, that comprises a TPU foam, to an inner surface of the outer skin, within the desired shape further includes placing the TPU foam of the desired shape within the corresponding desired shape of the molded TPU outer skin.

19. The method of claim 12, further including:
applying a second skin formed from a TPU elastomer onto the inner surface of the outer skin after the padding is applied; and
heat welding the second skin onto the inner surface of the outer skin, wherein the outer skin and the second skin define a bladder encapsulating the padding therein.

20. A composite component, comprising:
an outer skin that is formed from a thermoplastic polyurethane (TPU) elastomer, within a thermoforming mold, into a desired shape;
a mesh reinforcement layer formed from a blend of TPU and polyester fibers and attached to an inner surface of the outer skin;
a padding that is formed from a TPU foam and applied to the inner surface of the outer skin and comprising one of;
liquid TPU foam that is poured within the desired shape of the outer skin, wherein the liquid TPU foam expands within the desired shape and cures to a solid foam structure;
a plurality of gas-filled TPU beads that are melted to one another at points of contact of outer surfaces of adjacent beads, wherein the desired shape of the outer skin is filled with gas-filled TPU beads and steam is applied to the gas-filled TPU beads, melting the outer surfaces of the gas-filled TPU beads and melting adjacent beads to one another, forming a solid foam structure when cooled; or
one of:
TPU foam that is molded to a desired shape; or
TPU foam that is cut in the desired shape from a bulk piece of TPU foam;
wherein, the padding is applied by placing the TPU foam of the desired shape within the corresponding desired shape of the molded TPU outer skin;
at least one attachment clip made from TPU and adapted to secure the outer skin to a support frame; and
at least one of:
stitching, made from TPU fibers, and adapted to connect two separate pieces of TPU skin to form the outer skin;
stitching, made from TPU fibers, and adapted to secure the outer skin to the padding; and
at least one tie-down clip, made from TPU, adapted to secure the outer skin to the padding,
wherein, the outer skin, the mesh reinforcement layer, the padding, the at least one attachment clip, stitching and the at least one tie-down clip are adapted for unitary closed-loop recyclability with completely recoverable content.
